(19) United States
(12) Patent Application Publication
(10) Pub. No.: US 2026/0367695 A1
(43) Pub. Date: Nov. 19, 2026

(54) Optimized Low Power State Transition

(71) Applicant: Sandisk Technologies, Inc., Milpitas, CA (US)

(72) Inventors: Prerana DESALE, Bangalore (IN); Shubhamsha KARKADA, Bangalore (IN); Praveen Kumar BODA, Bangalore (IN); Arshad EBRAHIM, Bengaluru (IN)

(73) Assignee: Sandisk Technologies, Inc., Milpitas, CA (US)

(21) Appl. No.: 19/208,146

(22) Filed: May 14, 2025

(51) Int. Cl. G06F 1/3296

(52) U.S. Cl. CPC G06F 1/3296

(57) ABSTRACT

Upon receiving a wake up request, a low power wake up sequence turns on only a main processor (MP) so that the MP can read a host command. If the host command is an administrative command that does not require a data path, the MP executes the command and returns to the low power state, thereby avoiding a full wake up of the data storage device. When moving from one low power state to another low power state, only the delta (i.e., different) steps in entry and exit sequences are triggered, thereby avoiding a complete exit and entry sequence. In so doing, low power state transitions are improved and power is conserved.

### BACKGROUND OF THE DISCLOSURE

### Field of the Disclosure

Embodiments of the present disclosure generally relate to improving low power state transitions.

### Description of the Related Art

Data storage devices are used to store data for a host device. The host device will often send new data to the controller of the data storage device to be written to a memory device of the data storage device. The host device will also send read commands to the controller to instruct the controller to read data from the memory device and provide the data back to the host device.

The data storage device, when processing read and/or write commands, will typically be in a normal, or operational, power state. However, when not processing commands, the data storage device may enter a low power state either due to a command from the host device or due to preset timeout thresholds being met or exceeded.

The data storage device transitions between low power states and operational power states often. For example, when in a low power state, the host device may send a command which causes the data storage device to switch to an operational power state. Once the command is executed, the data storage device may then, oftentimes, revert back to the low power state.

Not all commands are processed in a normal, operational power state. There are some commands, such as administrative commands, that can be performed with less than all hardware (HW) or firmware (FW) components. Transitioning from the lower power state to the normal, or operational power state where all HW and FW components are awake, and then back again to the low power state takes time.

Therefore, there is a need in the art for improving low power state transitions.

### SUMMARY OF THE DISCLOSURE

Upon receiving a wake up request, a low power wake up sequence turns on only a main processor (MP) so that the MP can read a host command. If the host command is an administrative command that does not require a data path, the MP executes the command and returns to the low power state, thereby avoiding a full wake up of the data storage device. When moving from one low power state to another low power state, only the delta (i.e., different) steps in entry and exit sequences are triggered, thereby avoiding a complete exit and entry sequence. In so doing, low power state transitions are improved and power is conserved.

In one embodiment, a data storage device comprises: a memory device; and a controller coupled to the memory device, wherein the controller is configured to: receive a command; determine that less than all firmware (FW) and hardware (HW) components of the data storage device are used in executing the command; wake up less than all FW and HW components; and execute the command while less than all FW and HW components are awake.

In another embodiment, a data storage device comprises: a memory device; and a controller coupled to the memory device, wherein the controller is configured to: determine whether a MP needs to be woken up to move the data storage device from a first power state to a second power state; determine a delta of power mode between the first power state and the second power state; and execute the delta.

In another embodiment, a data storage device comprises: means to store data; and a controller coupled to the means to store data, wherein the controller is configured to: execute administrative commands without waking up the means to store data; perform a portion of a power state exit sequence; perform a portion of a power state entrance sequence, wherein the power state exit sequence and the power state entrance sequence have one or more identical steps and one or more different steps; and change the data storage device from a first power state to a second power state, wherein the first power state and the second power state are different.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is schematic illustration of handling a low power mode and administrative command according to one embodiment.

FIG. 3 is a flowchart illustrating handling a low power mode and administrative command according to one embodiment.

FIG. 4 is a schematic illustration of handling a low power mode and administrative command according to another embodiment.

FIG. 5 is a flowchart illustrating handling a low power mode and administrative command according to one embodiment.

FIG. 6 is a schematic illustration of transitioning from one low power state to another a low power state according to one embodiment.

FIG. 7 is a flowchart illustrating transitioning from one low power state to another a low power state according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Upon receiving a wake up request, a low power wake up sequence turns on only a main processor (MP) so that the MP can read a host command. If the host command is an administrative command that does not require a data path, the MP executes the command and returns to the low power state, thereby avoiding a full wake up of the data storage device. When moving from one low power state to another low power state, only the delta (i.e., different) steps in entry and exit sequences are triggered, thereby avoiding a complete exit and entry sequence. In so doing, low power state transitions are improved and power is conserved.

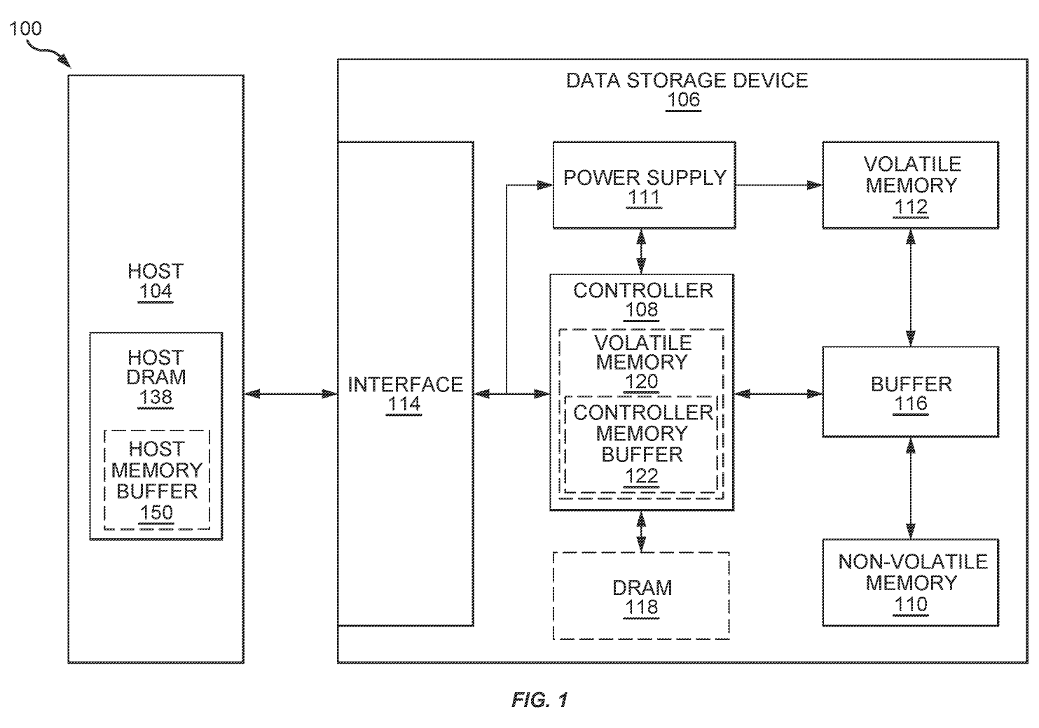

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host HMB 150 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

In solid state drives (SSDs), low power non-operational entry can occur under several conditions, such as when a set feature persistence memory module (PMM) power state 3/power state 4/power state 5 (PS3/PS4/PS5) command is issued by a host device, after an autonomous power state transition (APST) operational timer expires, when a D3.Hot power management write is triggered by the host device, or due to thermal throttling. Once a low power trigger is activated, the data storage device follows a low power entry sequence until reaching the lowest power state, with the sequence varying depending on the target power state.

Entry latency refers to the time taken for the data storage device to transition from acknowledging the PMM request to reaching the lowest or target power state. Exit latency is the time from receiving an exit trigger to being able to respond to commands. The various triggers that can initiate the exit from low power mode include CLOKREQ + Admin command, CLOKREQ + IO command, CLOKREQ + Config Write/Read, CLOKREQ + any type of reset (except PERST), and the APST Non-Operational timer. For PERST, the wake up is controlled by the pattern compute unit (PCU) context, which resets the data storage device and keeps the data storage device in the power state 0 (PS0) state. After the low power state exit sequence, the data storage device either stays in the operational power state (e.g., PS0) or returns to a low power mode, with all processors, such as the main processor (MP), power supply (PS), and low level file system (LLFS), and the memory device (e.g., NAND) turned on. However, in case of some administrative commands (e.g. identify, get feature, etc.), and APST, waking up all the processors is not required. Stated another way, a full wake up of the data storage device is unnecessary. Also, while moving from one low power state to another low power state, there is no need to execute the complete exit sequence and entry sequence before entering the next requested power state. It is to be noted that administrative commands may be referred to as admin commands or administrating commands or administrator commands.

As discussed herein, upon receiving a wake up request, the low power wake up sequence turns on only the MP so that the MP can read the host command. If the host command is an administrative command that does not require the data path, the MP services (e.g., executes) the command and returns to the low power state, thereby avoiding the full wake up of the data storage device. On the other hand, if data path operation is required for the host command (e.g., for a get log page admin command), then a non-pipelined data path (NPDP) is used for the memory device (e.g., NAND) read/writes.

Further, when moving from one low power state to another low power state, only the delta (i.e., different) steps in the entry sequence and exit sequence is triggered, thereby avoiding a complete exit and entry. That is, when moving from one lower power state to another low power state, the data storage device checks whether a TriggerDeltaChanges flag is set or not. If the flag is set, then only the delta steps between the two power states are performed, instead of following the complete low power entry sequence and exit sequence. If the flag is not set, the complete low power entry sequence and exit sequence is followed.

As discussed herein, a manner for low power state transition for NVMe and the resulting latency reduction and power consumption improvements is disclosed. The embodiments discussed herein will assist when moving from a first low power state to different, second low power state. Full wake up of the data storage device is unnecessary, and the power consumption can be optimized with an intelligent fast exit sequence or entry sequence.

While moving from one low power state to another, a full wake up of the data storage device is unnecessary, and power consumption can be optimized by an intelligent fast exit and entry sequence. The low power non-operational entry can happen upon the following events: set feature PMM PS3/PS4/PS5 command from the host device; APST operational timer expiry with the table of idle time timers (ITPT) and next power states (ITPS) supplied by the host device as part of a set feature APST command; D3.Hot power management configuration write initiated by the host device (mapped to PS5 low power state); and thermal throttling (PS3 low power state, no L1.2 transition).

The first of the NVMe based feature for low power state, PS3, PS4 and PS5, which will be issued by the host device in a set feature. The second of the NVMe based features is by an APST operational timer expiry. The host device configures an APST table with the ITPT and ITPS. Based on the ITPT and ITPS, the data storage device can go to the lowest power state if the data storage device is idle for the configured time period identified in the APST.

The third of the NVMe based features is the D3.Hot power management configuration, which is a PCIe based low power state transition issued by the host device only. In the third NVMe based feature, the data storage device goes to the lowest power state for D3.hot. The lowest power state is the lowest power state supported by the data storage device. The fourth NVMe based feature is thermal throttling. As part of thermal throttling, the data storage device moves to a low power state which is similar to PS3 where the link is not kept in the low power state.

The data storage device follows a low power entry sequence the moment the data storage device gets a low power trigger up to and until the lowest level of power consumption is reached. Based on each target power state, the sequence varies. For example, for PS3, PS4, and PS5 there will be a different power consumption, and therefore the sequence of turning on and off the different hardware components varies for each of PS3, PS4, and PS5.

Entry latency is the time gap between the moment when the data storage device sends acknowledge of a PMM request to a host device and the moment when the data storage device reaches the lowest possible level of power consumption. The low power state (LPS) sequence plays a crucial role in entry latency. Stated another way, entry latency is the time difference between the moment when the data storage device has sent the acknowledgment for the host set feature command until the time the data storage device actually goes into the lowest possible low power state by following the entry sequence for the low power state transition.

Exit latency is the time gap between the moment when an exit trigger is received by the data storage device to the moment when the data storage device is able to respond to the trigger, such as responding to a command. The data storage device follows the complete exit sequence and then responds to the host command, and the time gap therebetween is called as exit latency.

There are triggers for coming out of low power. The triggers are the following: CLOKREQ + Admin command; CLOCKREQ + IO command; CLOCKREQ + Config Wr/Read; CLOCKREQ + any type of reset except PERST; APST Non-Operational timer; and PERST.

For CLOKREQ + Admin command, after the wake up sequence and processing of an administrative command, the data storage device has to return to a non-operational state. The clock rate is the signal sent by the host device and the clock rate is sent for the admin command. After receiving the command, the data storage device will follow the wake up sequence and come to the operational state. The data storage device will then service the host command. Once the command is serviced, the data storage device will go back to the non-operational state.

CLOCKREQ + IO command. In this case, after the wake up sequence and processing of input/output (IO) command, the data storage device remains in the last operational state. The CLOCKREQ is issued for and an IO command. The data storage device will follow the wake up sequence and will service the IO command. The data storage device will stay in the operational power state and doesn't go back to the non-operational state.

CLOCKREQ + Config Wr/Read. In this case, after the wake up sequence and processing of Config Wr/Read, the data storage device has to return back to the non-operational state. Such commands behave the same as CLOCKREQ + Admin commands.

CLOCKREQ + any type of reset except PERST. In this case, after wake up, the data storage device should process the reset and remain in the last operational power state. The command applies to any type of reset issued by the host device except the administrative command, and the data storage device will follow the wake up flow. The data storage device will do the reset and remains in the operational power state only.

APST Non-Operational timer. In this case, the wake up sequence does not involve L1.2->L0 transition of PCIe Link. After the wake up, the data storage device enters into the next “deeper” non-operational power state. The APST non-operational timer is based on the host device configured timing. If the data storage device stays in the low power state or is idle for a threshold crossing pre-configured time, the data storage device transitions back to the next lowest power state from the current power state. The wake up sequence will be followed, and then the data storage device goes to the next lower power state.

For PERST, the wake up process is restricted by PCU context. When PCU finishes the wake up sequence, the PCU resets the data storage device with “Top + Him” (which includes MAC + PHY) reset. After that, the data storage device remains in the operational (i.e., PS0) state. PERST is the signal issued by the host device to trigger the reset. If the host device wants the data storage device to stay in the operational state, which is the PS0 power state, the data storage device goes through the reset sequence.

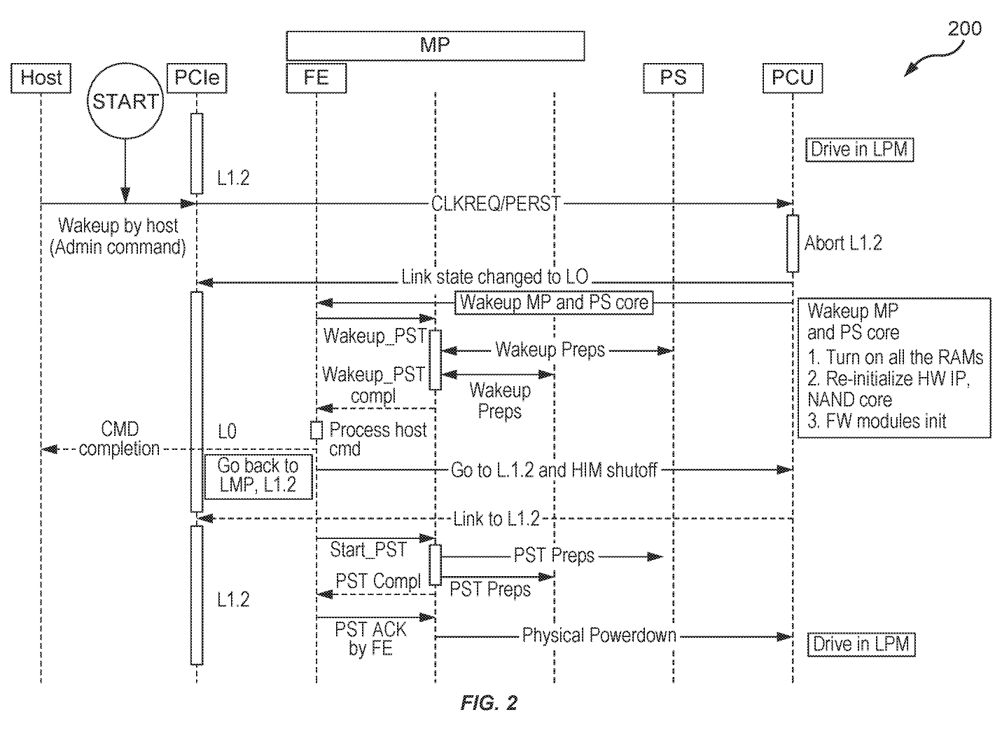

The data storage device follows a low power state exit sequence when the data storage device receives any of the trigger points discussed above. After the exit sequence, the data storage device remains in the previous operational power state and all the processors and memory device (e.g., NAND) in the data storage device are in the ON state. The processors include MP, PS, and LLFS. As listed above, the drive either continues in the operational power state or goes back to low power mode. FIG. 2 is schematic illustration 200 of handling a low power mode and administrative command according to one embodiment.

As shown in FIG. 2, the data storage device is in the low power state and the PCIe link is in the lowest state which is L1.2. The host device has initiated the wake up which means the host admin command is issued which comes as a CLOCKREQ to wake up to the data storage device. The data storage device will follow the sequence for aborting the L1.2 link state. Then, the data storage device will go to the L0 state. The state machine flow will be followed. Once in the L0 link state, the data storage device will follow the wake up sequence which involves waking up other cores and the hardware such as the MP and PS core. All of the processors will come out of the low power state. Then the hardware components also will be reinitialized and turned on, including RAM. Once the wake up sequence is complete, the data storage device executes the command and informs the host device by sending a completion to the host device. The data storage device will follow the flow for transitioning from the L0 link state to the L1.2 link state for example as shown in FIG. 2. For all of the components, the data storage device will become idle, and then data storage device will enter into the actual power low power state.

Stated another way with regards to FIG. 2, the host device issues an administrative command to wake up the data storage device, which is in the L1.2 link state, with the CLKREQ/PERST command. The controller aborts the L1.2 link and the wake up process begins. The link is changed to L0 link state. The controller wakes up the MP and PS core. The controller turns on all RAMs, re-initializes the hardware (HW) and memory device (e.g., NAND) core, and initializes the firmware (FW) modules. Wake up preparation occurs for the PS core and the flash transition layer (FTL). Once everything is woken up, then the controller processes the host device command and writes a completion to the host device for the command. The controller then goes to the L1.2 link state and shuts off the host interface module (HIM). The front end (FE) module then starts the power state transition (PST) and FTL begin PST preparation. Once PST is complete, then the PST completion is acknowledged by the FE and the physical power down occurs.

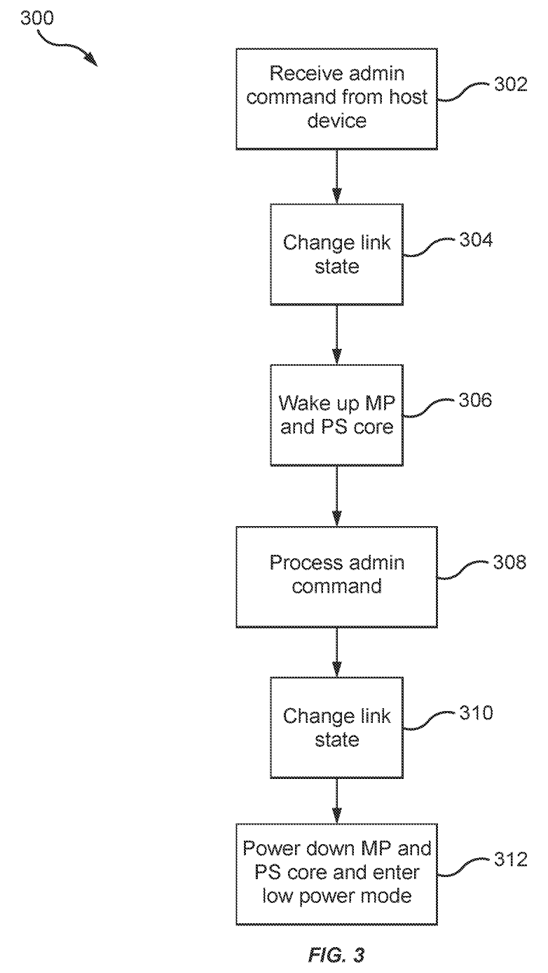

FIG. 3 is a flowchart 300 illustrating handling a low power mode and administrative command according to one embodiment. The process involves receiving an administrative command from a host device at block 302 while the data storage device is in low power mode. Due to the administrative command, the data storage device changes the link state 304, such as from L1.2 to L0. The data storage device then wakes up the MP and PS cores and generally all HW and FW modules and the memory device (e.g., NAND) at block 306 which effectively moves the data storage device out of the low power mode. The data storage device can then execute the administrative command at block 308 and post a completion to the host device. The data storage device can now change the link state at block 310 back to the previous link state, such as from L0 to L1.2. The data storage device can now power down the MP and PS core and enter the low power mode at block 312.

FIGS. 2 and 3 involve a complete exit from a low power state leading to redundant steps and elevated power consumption. As discussed herein, in case of some administrative commands (e.g. identify, get feature, etc.), and APST, waking up all the processors is not required. If the data path operations are not required to service the command/trigger, the MP alone can handle the host command.

Additionally, in case of moving from one low power state to another low power state, there is no need to execute the complete exit/entry sequence before entering the next requested power state. Redundant steps can be avoided. In this case, the data storage device does not need to follow the complete sequence for entry and exit before entering into the next requested power state. The controller can identify the delta changes between the two lower power states and just do those delta changes because some of the steps are redundant and the redundant steps will be avoided which will improve latency. Doing so addresses and optimizes higher power consumption during low power state transitions and administrative command handling in low power states by removing the redundant and common steps between the exit – process – entry cycle. After receiving the wake up request, a low power wake up sequence can turn on only the MP, and the MP can read the host command.

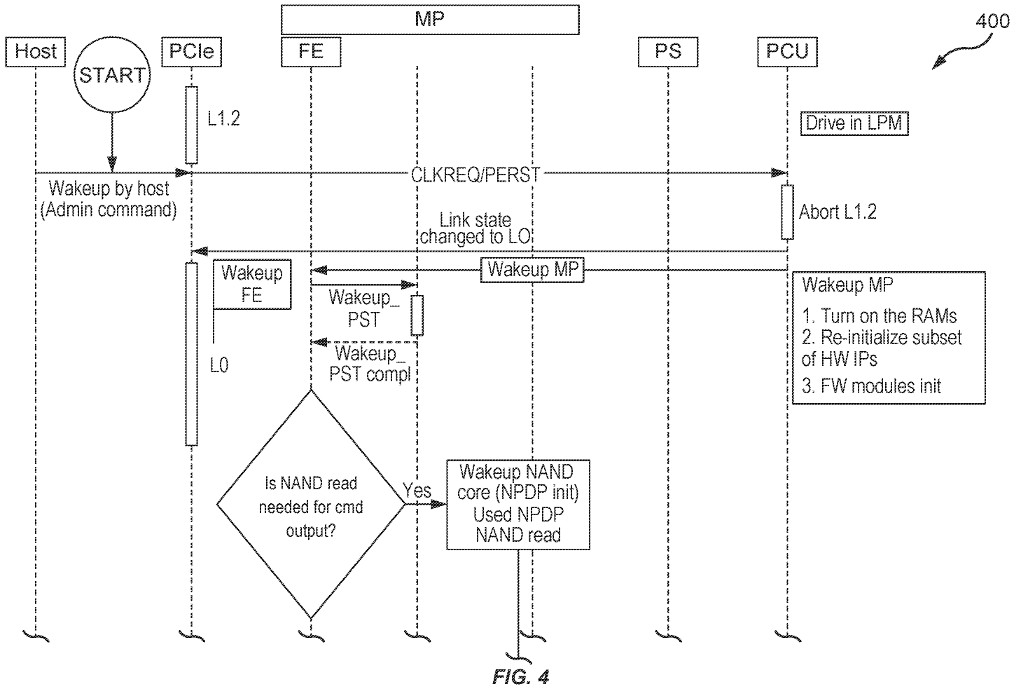

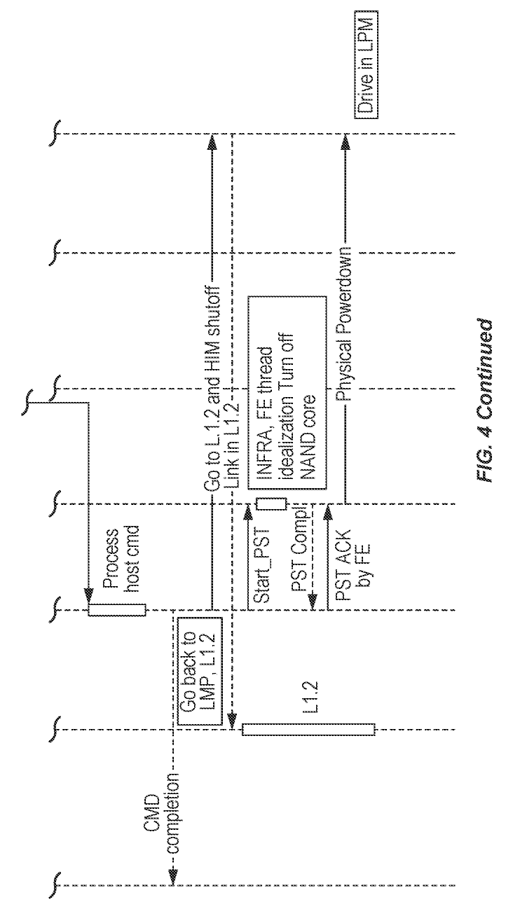

If the host command is an administrative command that does not need the data path, the MP will execute the command and return to a low power state. If the data path operation is required, then the controller will use a NPDP for memory device (e.g. NAND) read/writes (e.g. for a get log page admin command) as shown in FIG. 4. FIG. 4 is a schematic illustration 400 of handling a low power mode and administrative command according to another embodiment.

In FIG. 4, after receiving the wake up request, the low power wake up sequence will turn on only the MP. If the host command is an administrative command that does not need the data path, then the main processor alone can service the command and then the data storage device can return to the low power state quickly. So if command execution necessitates use of data path access, which is the memory device (e.g., NAND), then the controller needs to access the memory device. In that case rather, than following the data path flow like a pipelined access, the controller can go with the NPDP access which will not wake up the PS core or the other LLFS and HW accelerators. The data storage device utilizes the minimum, which will reduce latency and power consumption.

As a more specific example, if the data storage device is in a low power line state (e.g. L1.2) upon receiving an administrative command, then the data storage device will follow the abort L1.2 sequence. However, the data storage device will not wake up all the cores, but will simply wake up the MP core and FE module so that the minimum wake up flow occurs. The controller will check if the incoming host command involves memory device access or not. For example, if the command is a gate lock page command, which involves the controller reading from the memory device, the controller will wake up the memory device. The controller will wake up the memory device port by doing the initialization flow for the NPDP. Then the controller can use the NPDP to do the read and fetch the data. The controller can then send the completion to the host device and go back to the low power state. Because there is not a complete wake up flow and hence, latency, the data storage device can quickly go into the low power state by following the minimum wake up flow. By doing so, the time that the data storage device is in the L0 state is significantly reduced compared to FIG. 2 and the time to get back L1.2 is quicker.

More specifically with regards to FIG. 4, the host device issues an admin command to wake up the data storage device from the L1.2 link state using a CLKREQ/PERST to the PCU. The PCU then aborts the L1.2 link state and begins the wake up process of turning on the RAMs, re-initializing a subset of HW modules, and initializing FW modules. More specifically, the link state is changed to L0 and the MP is woken up with only the FE module being woken up by sending a wake up PST followed by a wake up PST completion. A determination is then made regarding whether a memory device (e.g., NAND) read is needed for the command output. If yes, then the memory device (e.g., NAND) core is woken up via NPDP initialization where the NPDP is used for reading from the memory device followed by processing of the host command. If memory device access is not needed, then the host command is simply executed. Following execution of the host command, a command completion is posted to the host device followed by changing to the L1.2 link state and shutting off the HIM. The FE then starts the PST and, if necessary, the memory device core is turned off while the FE module becomes idle whereupon the PST is complete. The PST is then acknowledged by the FE module, and the physical power down occurs to place the data storage device in a low power mode.

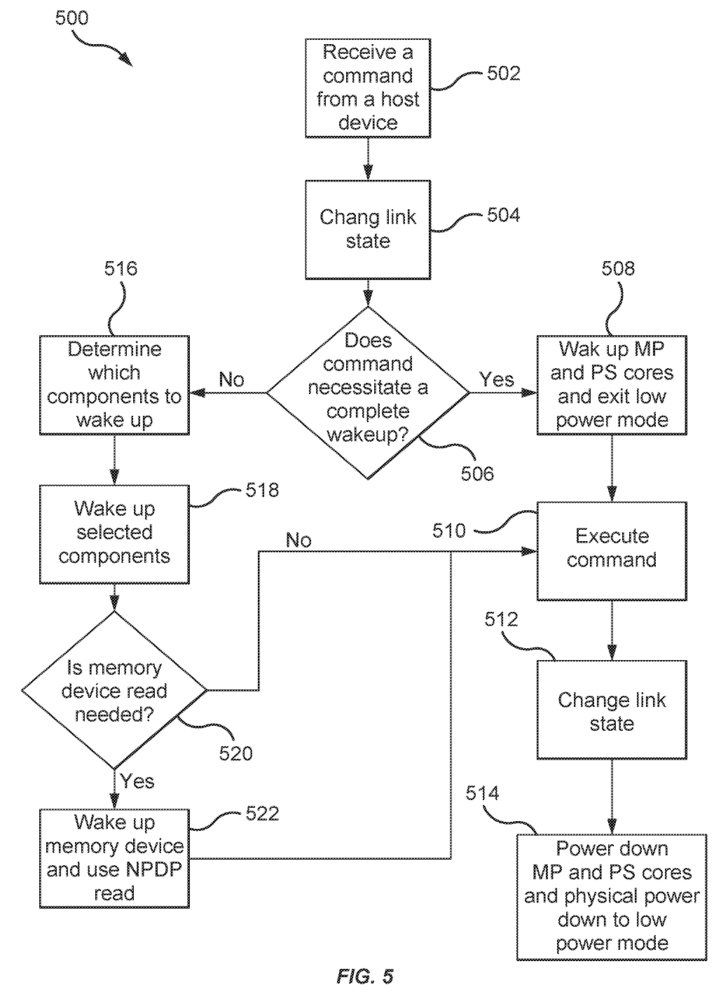

FIG. 5 is a flowchart 500 illustrating handling a low power mode and administrative command according to one embodiment. Initially, a command is received from a host device at block 502 and the link state is changed at block 504, such as from L1.2 to L0. A determination is then made regarding whether the command execution necessitates a complete wake up at block 506. A complete wake up would be where the MP and PS cores and FTL are woken up as is the memory device.

If executing the command necessitates a complete wake up, then at block 508, the MP and PS cores are woken up and the data storage device exits low power mode. The command is then executed at block 510 followed by a completion notification being posted to the host device. The link state is then changed at block 512, such as from L0 back to L1.2, followed by powering down the MP and PS cores and a physical power down to low power mode at block 514.

If executing the command does not necessitate a complete wake up, then only the delta (i.e., only the HW and/or FW modules needed) will be powered up. Specifically, the data storage device determines which components to wake up (i.e., which components are the delta) at block 518. Thereafter the delta components are woken up at block 518. A determination is then made at block 520 regarding whether the memory device (e.g., NAND) is needed for a read operation. If the memory device is needed, then the memory device is woken up and a NPDP read occurs at block 522 followed by a return to block 510. If the memory device is not needed at block 520, then the process returns to block 510.

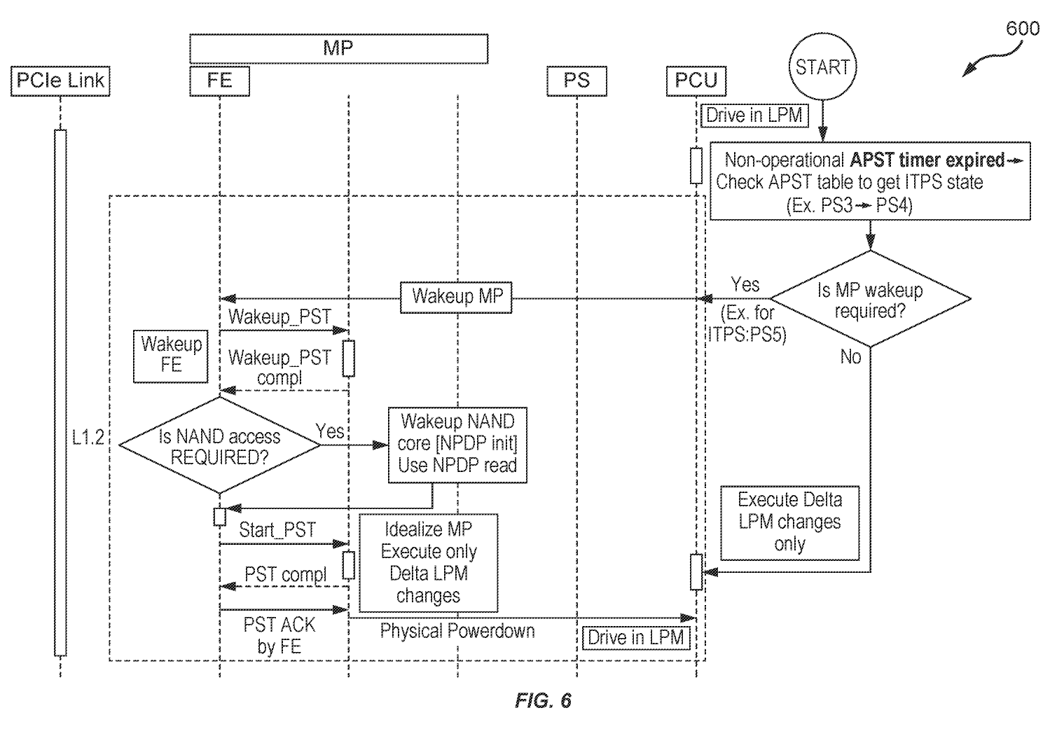

In case of moving from one low power state to another low power state, only the delta (difference) steps need to be triggered, and complete exit and entry can be avoided. While moving to a low power state again, the controller checks whether the TriggerDeltaChanges flag is set or not. If the flag is set, only the delta between the two power states is performed instead of following the complete low power sequence. If the flag is not set, the controller follows the complete low power entry sequence. FIG. 6 is a schematic illustration 600 of transitioning from one low power state to another a low power state according to one embodiment.

In FIG. 6, the data storage device will figure out the trigger changes and can check if the data storage device needs to just trigger the delta changes. If there is a flag, then the controller simply performs the delta steps, not the complete flow. For example, if the data storage device is in one low power state because of APST, such as the PS3 power state, and the data storage device is idle for the configured times, the timer will expire and now the data storage device needs to go to the PS4 power stage. Currently, the data storage device does the complete wake up from PS3 to PS0 and then will go back to PS4. However, as shown in FIG. 6, a determination is made regarding whether the MP wake up is required. In yes, then the controller will wake up the MP core and will do the minimum wake up only and after that wake up will determine if memory device (e.g., NAND) access is required. If memory device access will be required, then the memory device is woken up using the NPDP initialization and image to the RAM which will be result in low exit latency. The data storage device can immediately load and come back to the non-operational power state. The data storage device needs memory device access during the entry of some low power states, so the controller will check if access is required. The controller will start the entry flow for the next power state, for example PS4, and then will just make the MP idle and execute only the delta changes between the PS3 to PS4. Once the delta changes are done, the actual HW will be turned off and the data storage device will enter into the PS4 power state and thus reducing the latency for entering into another low power state and the power consumption.

More specifically in regards to FIG. 6, the non-operational APST timer has expired while the data storage device is in the L1.2 link state. The ASPT table is checked to obtain the ITPS state (e.g., PS3 to PS4). A determination is made regarding whether the MP wake up is required. If the MP wake up is not required, then the delta low power mode changes are executed and the data storage device is in low power mode. If MP wake up is needed, then the MP is woken up. When the MP is woken up, the FE is woken up and others are not. The FE sends a wake up PST, which is completed. A determination is then made regarding whether memory device (e.g., NAND) access is required. If memory device access is required, then the memory device (e.g., NAND) core is woken up via NPDP initialization where the NPDP is used for reading from the memory device. Thereafter, the PST begins to place the MP in idle state and execute only the delta low power mode changes. If memory device access is not required, then the PST is started to place the MP in idle state and execute only the delta low power mode changes. Once the delta low power mode changes have been executed, then a PST completion is sent to the FE module followed by an acknowledgement from the FE module which results in the data storage device being in low power mode.

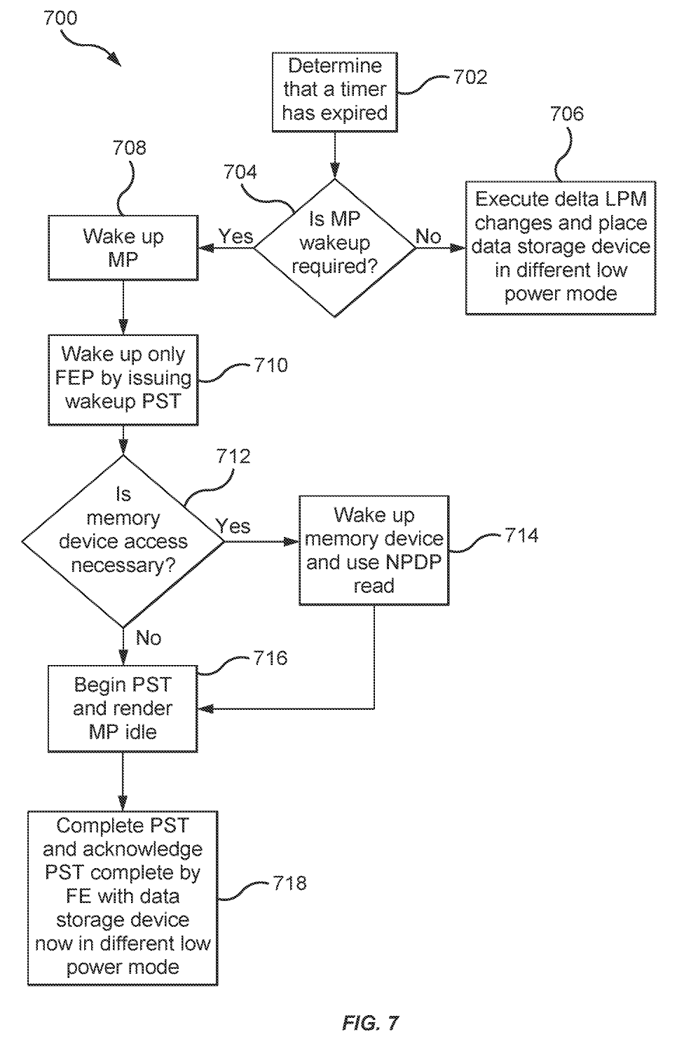

FIG. 7 is a flowchart 700 illustrating transitioning from one low power state to another a low power state according to one embodiment. Initially, a determination is made that a timer has expired at block 702. The timer can be a non-operational APST timer that has a predetermined time period set by the host device and stored in an APST table. The APST table also includes the ITPS state (e.g., PS3 to PS4).

A determination is then made regarding whether the MP needs to be woken up at block 704. If no, then the delta low power mode changes are executed and the data storage device is simply placed in a different low power mode at block 706.

If the MP needs woken up, then the MP is woken up at block 708 followed by waking up only the FE module by issuing a wake up PST at block 710. A determination is then made at block 712 regarding whether memory device access is necessary. If necessary, then the memory device is woken up and a NPDP read is performed at block 714 followed by beginning a PST and rendering the MP idle at block 716. If memory device access is not necessary, then the process simply skips block 714 and proceeds to block 716. Thereafter, the PST is completed and acknowledged by the FE so that the data storage device is now in a different low power mode state at block 718.

In regards to the delta discussed above, the delta is understood to be a difference. For example, when performing a power state exit sequence, the power state exit sequence may comprise steps 1-6. When performing a power state entrance sequence, the power state entrance sequence may comprise steps 1-3 and 5-7. Thus, the delta is steps 4 and 7. Steps 1-3, 5, and 6 are redundant and there is no need to perform redundant steps. Therefore, when performing the delta, steps 4 and 7 are performed. As discussed herein, there is a benefit in performing only the delta (i.e., perform steps 4 and 7, but do not perform steps 1-3, 5, and 6) because performing only steps 4 and 7 saves the controller from performing steps 1-3, 5, and 6 which will reduce latency and power consumption. The benefits of FIGS. 4-7 is eliminating the redundancy.

In regards to waking up components, it is to be noted that one of the benefits of FIGS. 4-7 is to wake up less than all components compared to FIGS. 2 and 3. For example, in FIG. 2, the entire MP and PS core are woken up. The memory device is also woken up too. Contrasting with FIG. 4, the PS core is not woken up, and only part of the MP is woken up. In particular, the FE module in the MP is woken up, but the FTL is not woken up in FIG. 4. Additionally, the memory device may or may not be woken up, but if the memory device is woken up, the wake up is for a NPDP read which is significantly faster than a traditional read from a memory device. In regards to FIG. 6, the PS core is not woken up, and the MP may or may not be woken up. If woken up, the MP, like in FIG. 4, only has the FE module woken up while the FTL is not woken up. Similar to FIG. 4, the memory device may or may not be woken up, but if the memory device is woken up, the wake up is for a NPDP read. Waking up less than all components means less than all components are powered and less time is needed to wake up the components. Thus, waking up less than all components leads to reduced latency and power consumption.

It is to be understood that there are numerous power states: PS0, PS1, PS2, and PS3. PS0 is the highest performance state. PS1 is lower performance than PS0, PS2 is lower performance than PS1, and PS3 is the lowest performance state such as when the device is idle. Thus, PS0 is the high power state, PS3 is the lowest power state, and PS1 and PS2 are between PS0 and PS3. PS1, PS2, and PS3 can be considered low power states relative to PS0. PS2 and PS3 can be considered low power states relative to PS0 and PS1. PS0, PS1, and PS2 can be considered higher power states relative to PS3. PS0 and PS1 can be considered higher power states relative to PS2 and PS3. Thus, as an example of moving between a low power state to a high power state and back to a low power state, the data storage device may move from PS3 to PS0 to PS3 in FIG. 2 for example. For FIG. 4, the data storage device may move from PS3 to PS2, PS1, or PS0 and then back to PS3 for example. More generally, for FIG. 4, the data storage device may move from any power state (other than PS0) to any other higher power state (other than PS3) and then back to any power state (other than PS0). For FIG. 6, the data storage device may simply remain in PS3 or PS2 or PS1, for example. The power state is to be distinguished from the link state, which is the PCIe link between the host device and the data storage device. FIGS. 2 and 4 exemplify switching the link state while FIG. 6 exemplifies no change to the link state.

By using the embodiments discussed herein, entry and exit latency will improve by as much as 10 percent. Additionally, data storage device power consumption will reduce by as much as 5 percent, and response time to the host device for certain administrative commands will improve by as much as 10 percent. In the case of administrative commands that do not need data path access, a partial wake up can significantly reduce the exit latency and command latency as observed by the host device which simplifies entry/exit flows leading to minimization of faults in the state machine which will have, for example, 40 percent less steps.

In one embodiment, a data storage device comprises: a memory device; and a controller coupled to the memory device, wherein the controller is configured to: receive a command; determine that less than all FW and HW components of the data storage device are used in executing the command; wake up less than all FW and HW components; and execute the command while less than all FW and HW components are awake. The data storage device is in a first link state when receiving the command and a second link state when waking up the less than all FW and HW components, and wherein the first link state and the second link state are different. The controller is configured to return the data storage device to the first link state after the executing. The data storage device is in a first power state when receiving the command. The data storage device is in a second power state when executing the command and wherein the second power state is different from the first power state. The second power state is a higher power state compared to the first power state. The controller is configured to determine whether the memory device is needed for the executing. The controller is configured to wake up the memory device upon determining that the memory device is needed for the executing. The controller is configured to execute the command using a NPDP read operation. After the wake up, one or more HW or FW components are not awake and remain not awake during the executing.

In another embodiment, a data storage device comprises: a memory device; and a controller coupled to the memory device, wherein the controller is configured to: determine whether a MP needs to be woken up to move the data storage device from a first power state to a second power state; determine a delta of power mode between the first power state and the second power state; and execute the delta. The data storage device only performs the delta and does not perform a complete power state exit sequence when exiting the first power state. The data storage device only performs the delta and does not perform a complete power state entrance sequence when entering the second power state. The delta is different steps performed during a power state exit sequence and a power state entrance sequence. The power state exit sequence and the power state entrance sequence have one or more common steps. The controller is configured to wake up the MP. The controller is configured to determine if the memory device needs to be woken up to perform the executing.

In another embodiment, a data storage device comprises: means to store data; and a controller coupled to the means to store data, wherein the controller is configured to: execute administrative commands without waking up the means to store data; perform a portion of a power state exit sequence; perform a portion of a power state entrance sequence, wherein the power state exit sequence and the power state entrance sequence have one or more identical steps and one or more different steps; and change the data storage device from a first power state to a second power state, wherein the first power state and the second power state are different. The portion of the power state exit sequence and the portion of the power state entrance sequence are the one or more different steps. The one or more identical steps are not performed.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
receive a command;
determine that less than all firmware (FW) and hardware (HW) components of the data storage device are used in executing the command;
wake up less than all FW and HW components; and
execute the command while less than all FW and HW components are awake.

2. The data storage device of claim 1, wherein the data storage device is in a first link state when receiving the command, wherein the data storage device is in a second link state when waking up the less than all FW and HW components, and wherein the first link state and the second link state are different.

3. The data storage device of claim 2, wherein the controller is configured to return the data storage device to the first link state after the executing.

4. The data storage device of claim 1, wherein the data storage device is in a first power state when receiving the command.

5. The data storage device of claim 4, wherein the data storage device is in a second power state when executing the command and wherein the second power state is different from the first power state.

6. The data storage device of claim 5, wherein the second power state is a higher power state compared to the first power state.

7. The data storage device of claim 1, wherein the controller is configured to determine whether the memory device is needed for the executing.

8. The data storage device of claim 7, wherein the controller is configured to wake up the memory device upon determining that the memory device is needed for the executing.

9. The data storage device of claim 8, wherein the controller is configured to execute the command using a non-pipelined data path (NPDP) read operation.

10. The data storage device of claim 1, wherein after the wake up, one or more HW or FW components are not awake and remain not awake during the executing.

11. A data storage device, comprising:
a memory device; and
a controller coupled to the memory device, wherein the controller is configured to:
determine whether a main processor (MP) needs to be woken up to move the data storage device from a first power state to a second power state;
determine a delta of power mode between the first power state and the second power state; and
execute the delta.

12. The data storage device of claim 8, wherein the data storage device only performs the delta and does not perform a complete power state exit sequence when exiting the first power state.

13. The data storage device of claim 8, wherein the data storage device only performs the delta and does not perform a complete power state entrance sequence when entering the second power state.

14. The data storage device of claim 8, wherein the delta is different steps performed during a power state exit sequence and a power state entrance sequence.

15. The data storage device of claim 14, wherein the power state exit sequence and the power state entrance sequence have one or more common steps.

16. The data storage device of claim 8, wherein the controller is configured to wake up the MP.

17. The data storage device of claim 8, wherein the controller is configured to determine if the memory device needs to be woken up to perform the executing.

18. A data storage device, comprising:
means to store data; and
a controller coupled to the means to store data, wherein the controller is configured to:
execute administrative commands without waking up the means to store data;
perform a portion of a power state exit sequence;
perform a portion of a power state entrance sequence, wherein the power state exit sequence and the power state entrance sequence have one or more identical steps and one or more different steps; and
change the data storage device from a first power state to a second power state, wherein the first power state and the second power state are different.

19. The data storage device of claim 18, wherein the portion of the power state exit sequence and the portion of the power state entrance sequence are the one or more different steps.

20. The data storage device of claim 18, wherein the one or more identical steps are not performed.
